(19) United States
(12) Patent Application Publication
(10) Pub. No.: US 2014/0035653 A1
(43) Pub. Date: Feb. 6, 2014

(54) CAPACITANCE SENSING DEVICE AND TOUCHSCREEN

(71) Applicant: SAMSUNG ELECTRO-MECHANICS CO., LTD., SUWON (KR)

(72) Inventors: Moon Suk JEONG, Suwon (KR); YONG II KWON, SUWON (KR); BYEONG HAK JO, SUWON (KR); TAH JOON PARK, SUWON (KR)

(73) Assignee: SAMSUNG ELECTRO-MECHANICS CO., LTD., SUWON (KR)

(21) Appl. No.: 13/669,892

(22) Filed: Nov. 6, 2012

(30) Foreign Application Priority Data
Jul. 31, 2012 (KR) 10-2012-0084155

(51) Int. Cl. G06G 7/184

(52) U.S. Cl. 327/337

(57) ABSTRACT

There are provided a capacitance sensing device and a touchscreen, the capacitance sensing device including a driving circuit unit allowing a capacitor to be charged and discharged; and an integrating circuit unit integrating charges stored in the capacitor, wherein the integrating circuit unit integrates the charges stored in the capacitor to thereby output a first voltage having a positive polarity and a second voltage having a negative polarity.

### CROSS-REFERENCE TO RELATED APPLICATIONS

This application claims the priority of Korean Patent Application No. 10-2012-0084155 filed on Jul. 31, 2012, in the Korean Intellectual Property Office, the disclosure of which is incorporated herein by reference.

### BACKGROUND OF THE INVENTION

1. Field of the Invention

The present invention relates to a capacitance sensing device and a touchscreen, capable of significantly reducing an influence of noise.

2. Description of the Related Art

A touch sensing device, such as a touchscreen, a touch pad, or the like, is an input device attached to a display device to provide an intuitive data input method to a user. Recently, various electronic devices, such as a mobile phone, a personal digital assistant (PDA), a navigation system, and the like, have come into widespread use. Especially, as demand for mobile phones has increased in recent years, touchscreens have increasingly been adopted for use therein as touch sensing devices capable of providing various data input methods in a limited form factor.

Touchscreens applied to mobile devices may largely be classified as resistive-type touchscreens or capacitive-type touchscreens, depending on the method of sensing a touch input utilized thereby. Capacitive-type touchscreens are increasingly being used, due to the advantages thereof, such as a relatively long lifespan and simple implementation of various input methods and gestures. In particular, capacitive-type touchscreens allow for easier implementation of a multi-touch interface as compared with the resistive-type touchscreens, and are thus widely applied to devices such as smart phones and the like.

Capacitive-type touchscreens may include a plurality of electrodes having a predetermined pattern, and a plurality of nodes in which capacitance is changed due to touch input may be defined by the plurality of electrodes. The plurality of nodes distributed on a two-dimensional planar surface generate a change in self-capacitance or a change in mutual-capacitance due to the touch input, and coordinates of the touch input may be calculated by applying a weighted average calculation method or the like to changes in capacitance generated in the plurality of nodes. In order to accurately calculate the coordinates of the touch input, a technology of accurately sensing the changes in capacitance generated in the plurality of nodes due to the touch input is required. However, electric noise generated from a wireless communications module, a display device, or the like, may interfere with accuracy in the sensing of changes in capacitance.

Patent Document 1 discloses an integrating circuit in which an inverting integrator circuit and a non-inverting integrator circuit are combined. Here, signals having opposite phases are respectively applied to inverting terminals of two operational amplifiers to remove noise therefrom, but in the case in which the frequency of the noise therein is equal to or higher than the operational frequency of the integrating circuit, the noise may not be effectively removed therefrom.

### RELATED ART DOCUMENT

(Patent Document 1) Korean Patent Laid-Open Publication No. 10-2011-0126026

### SUMMARY OF THE INVENTION

An aspect of the present invention provides a method of significantly reducing noise in the case in which a change in capacitance to be measured is influenced thereby. According to the present invention, the influence of noise is removed by using a difference in voltage between a positive output voltage and a negative output voltage generated by integrating charges stored in a capacitor during different time periods.

According to an aspect of the present invention, there is provided a capacitance sensing device, including: a driving circuit unit allowing a capacitor to be charged and discharged; and an integrating circuit unit integrating charges stored in the capacitor, wherein the integrating circuit unit integrates the charges stored in the capacitor to thereby output a first voltage having a positive polarity and a second voltage having a negative polarity.

In the integrating circuit unit, an integrating period in which the first voltage having the positive polarity is output may not overlap with an integrating period in which the second voltage having the negative polarity is output.

The driving circuit unit may include a first switch connecting a first terminal of the capacitor to a first potential; and a second switch connecting the first terminal of the capacitor to a second potential.

The integrating circuit unit may include a third switch having one end connected to a second terminal of the capacitor; a fourth switch having one end connected to the second terminal of the capacitor; an operational amplifier having a non-inverting input terminal and an inverting input terminal respectively connected to the other end of the third switch and the other end of the fourth switch; a first feedback capacitor connecting the non-inverting input terminal and a non-inverting output terminal of the operational amplifier; and a second feedback capacitor connecting the inverting input terminal and an inverting output terminal of the operational amplifier.

The first switch and the third switch may be driven by a first clock and the second switch and the fourth switch may be driven by a second clock, and the first clock and the second clock may be in an ON-state during different time periods.

The first feedback capacitor and the second feedback capacitor may have the same capacitance.

The integrating circuit unit may further include a first reset switch and a second reset switch respectively connected to the first feedback capacitor and the second feedback capacitor in parallel.

According to another embodiment of the present invention, there is provided a touchscreen, including: a panel unit including a plurality of driving electrodes and a plurality of sensing electrodes; a driving circuit unit applying a driving signal to each of the plurality of driving electrodes; a sensing circuit unit sensing changes in capacitance generated in intersections between the driving electrodes to which the driving signal is applied and the sensing electrodes; and a control unit controlling operations of the driving circuit unit and the sensing circuit unit, wherein the sensing circuit unit includes an integrating circuit unit integrating charges stored in the sensing electrodes to thereby output a first voltage having a positive polarity and a second voltage having a negative polarity.

In the integrating circuit unit, an integrating period in which the first voltage having the positive polarity is output may not overlap with an integrating period in which the second voltage having the negative polarity is output.

The control unit may determine a touch input applied to the panel unit depending on a difference between the first voltage having the positive polarity and the second voltage having the negative polarity output from the integrating circuit unit.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a perspective view showing an exterior of an electronic device including a touchscreen according to an embodiment of the present invention;

FIG. 2 is a diagram showing a touchscreen having a capacitance sensing device according to an embodiment of the present invention;

FIG. 3 is a block diagram showing a capacitance sensing device according to an embodiment of the present invention;

FIG. 4 is a circuit diagram showing a capacitance sensing device according to an embodiment of the present invention;

FIG. 5 is a diagram showing the on/off timing of first to fourth switches according to an embodiment of the present invention; and

FIGS. 6 to 9 show simulation results according to an embodiment of the present invention.

### DETAILED DESCRIPTION OF THE EMBODIMENTS

Embodiments of the present invention will hereinafter be described in detail with reference to the accompanying drawings. These embodiments will be described in detail to allow those skilled in the art to practice the present invention. It should be understood that various embodiments of the present invention are different but are not necessarily exclusive. For example, specific shapes, configurations, and characteristics of elements described in an embodiment of the present invention may be implemented in other embodiments without departing from the spirit and the scope of the present invention. In addition, it should be understood that positions and arrangements of individual components in each disclosed exemplary embodiment may be changed without departing from the spirit and the scope of the present invention. Therefore, the detailed description provided below should not be construed as having restrictive meanings. The scope of the present invention is limited only by the accompanying claims and their equivalents, if appropriately described. Similar reference numerals will denote the same or similar functions throughout the accompanying drawings.

Hereinafter, embodiments of the present invention will be described in detail with reference to the accompanying drawings so that those skilled in the art may easily practice the present invention.

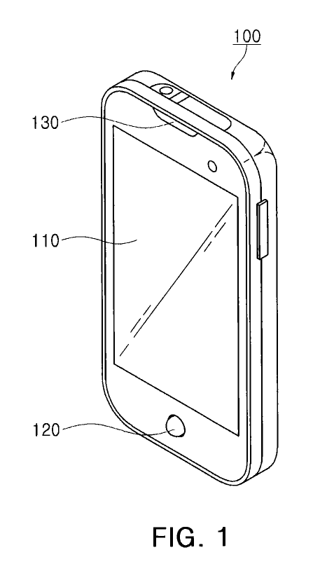

FIG. 1 is a perspective view showing an exterior of an electronic device including a touchscreen according to an embodiment of the present invention. Referring to FIG. 1, an electronic device 100 according to the present embodiment may include a display device 110 for outputting a screen, an input device 120, an audio device 130 for outputting a sound, and the like, and may include a touchscreen integrally formed with the display device 110.

As shown in FIG. 1, in the case of a mobile electronic device, a touchscreen is generally provided integrally with a display device. The light transmittance of the touchscreen needs to be sufficiently high so that an image displayed by the display device can be transmitted therethrough. Therefore, the touchscreen may be realized by forming sensing electrodes of a material, such as indium tin oxide (ITO), indium zinc oxide (IZO), zinc oxide (ZnO), carbon nanotube (CNT) or graphene, having transparency and electrical conductivity, on a base substrate of a transparent film material, such as polyethylene terephthalate (PET), polycarbonate (PC), polyethersulfone (PES), polyimide (PI), or the like. Wiring patterns are disposed in a bezel area of the display device, the wiring patterns being connected to the sensing electrodes formed of the transparent conductive material. Since the wiring patterns are visibly shielded by the bezel area, the wiring patterns may be formed of a metal, such as silver (Ag), copper (Cu), or the like.

The touchscreen may include a plurality of electrodes having a predetermined pattern. In addition, the touchscreen may include a capacitance sensing device for detecting a change in capacitance generated in the plurality of electrodes.

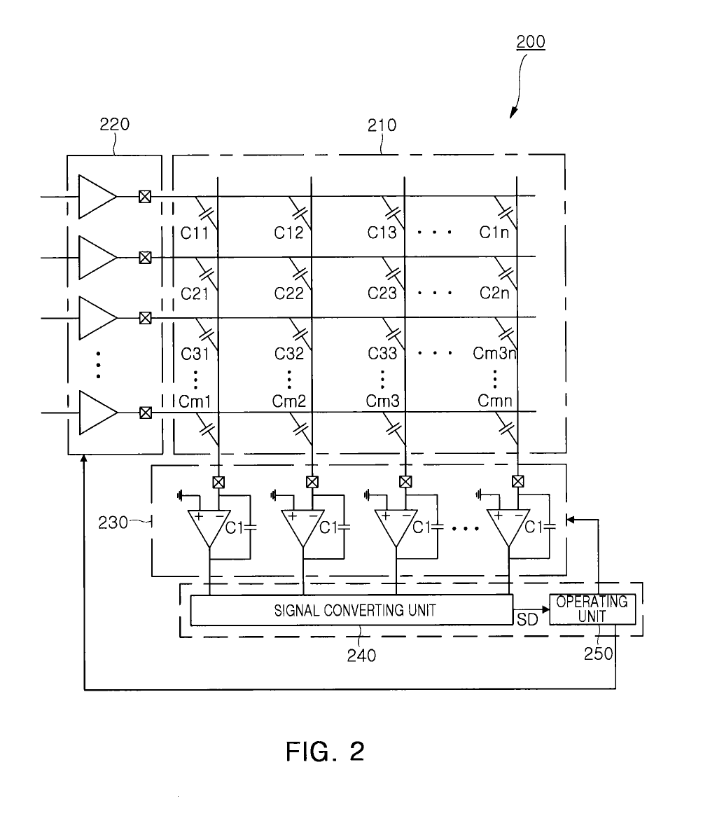

FIG. 2 is a diagram showing a touchscreen having a capacitance sensing device according to an embodiment of the present invention.

Referring to FIG. 2, a touchscreen 200 according to the embodiment of the present invention may include a panel unit 210, a driving circuit unit 220, a sensing circuit unit 230, a signal converting unit 240, and an operating unit 250. The panel unit 210 may include a plurality of first electrodes extended in a first-axis direction, that is, a width direction of FIG. 2, and a plurality of second electrodes extended in a second-axis direction perpendicular to the first-axis, that is, a length direction of FIG. 2. The first electrodes may correspond to driving electrodes and the second electrodes may correspond to sensing electrodes.

Node capacitors in which charges are stored or from which charges are discharged may be formed by changes in mutual capacitance generated in intersections between the first electrodes and the second electrodes. The changes in capacitance generated in the intersections between the first electrodes and the second electrodes may be generated by a driving signal that is applied to the first electrodes by the driving circuit unit 220. In FIG. 2, a node capacitor formed by an i-th first electrode and a j-th second electrode is designated Cij. Meanwhile, the driving circuit unit 220, the sensing circuit unit 230, the signal converting unit 240, and the operating unit 250 may be embodied in a single integrated circuit (IC).

The driving circuit unit 220 may apply a predetermined driving signal to the first electrodes. The driving signal may have a square wave, a sine wave, a triangle wave, or the like, having a predetermined period and amplitude, and may be sequentially applied to the plurality of first electrodes. Although FIG. 2 shows that circuits for generating and applying the driving signal may be individually connected to the plurality of first electrodes respectively, a single driving signal generating circuit may be provided to apply the driving signal to the plurality of first electrodes by using a switching circuit.

The sensing circuit unit 230 may include an integrating circuit unit for sensing the changes in capacitance of the node capacitors. The integrating circuit unit may include at least one operational amplifier and a capacitor C1 having a predetermined capacitance. An input terminal of the operational amplifier is connected to the second electrode to convert the change in capacitance of the node capacitor into an analog signal such as a voltage signal or the like and output the same. In the case in which the driving signal is sequentially applied to the plurality of first electrodes, the changes in capacitance therein may be simultaneously detected by the plurality of second electrodes, and thus the number of integrating circuits may be equal to the number of second electrodes.

The signal converting unit 240 generates a digital signal (SD) from the analog signal generated from the integrating circuit. For example, the signal converting unit may include a time-to-digital converter (TDC) circuit or an analog-to-digital converter (ADC) circuit. The TDC circuit measures time taken for the analog signal output by the sensing circuit unit 230 in a voltage form to reach a predetermined reference voltage level and then converts the measured time into a digital signal (SD). The ADC circuit measures an amount by which the level of the analog signal output by the sensing circuit unit 230 is changed during a predetermined time period, and then converts the measured amount into a digital signal (SD).

The operating unit 250 determines the touch input applied to the panel unit 210 by using the digital signal (SD). For example, the operating unit 250 may determine the number of touch inputs applied to the panel unit 250 and the coordinates thereof, gesture motions, and the like.

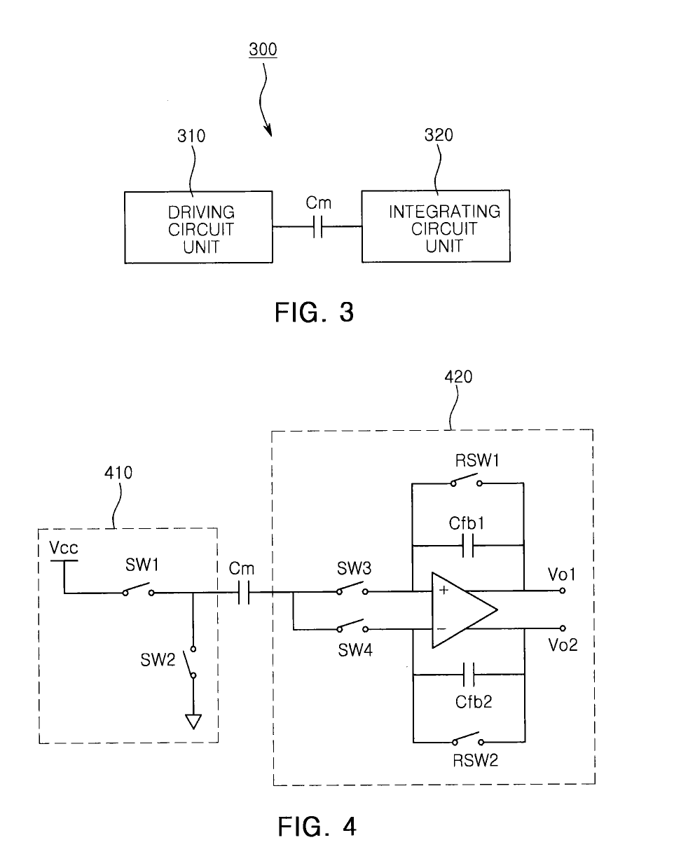

Hereinafter, the capacitance sensing device and operations thereof will be described with reference to FIGS. 2 and 3.

FIG. 3 is a block diagram showing a capacitance sensing device according to an embodiment of the present invention. Referring to FIG. 3, a capacitance sensing device 300 according to the present embodiment may include a driving circuit unit 310 and an integrating circuit unit 320. The driving circuit unit 310 may be connected to a capacitor Cm to charge the capacitor Cm by a driving power and discharge the capacitor Cm by a ground voltage (GND).

The capacitor Cm of FIG. 3 corresponds to a capacitor having a capacitance that will be measured by the capacitance sensing device 300 according to the present embodiment. For example, the capacitance in the capacitor Cm may correspond to mutual capacitance generated between the plurality of electrodes included in a capacitive-type touchscreen. Hereinafter, for convenience of explanation, it is assumed that the capacitance sensing device 300 according to the embodiment of the present invention is able to sense a change in capacitance generated in the capacitive type touchscreen. In this case, the capacitor Cm is a node capacitor in which charges are stored or discharged due to the changes in mutual capacitance generated in the intersection between the plurality of electrodes.

The integrating circuit unit 320 may integrate the charges stored in the capacitor Cm to output a first voltage having a positive polarity and a second voltage having a negative polarity.

FIG. 4 is a circuit diagram showing a capacitance sensing device according to an embodiment of the present invention. Referring to FIG. 4, a capacitance sensing device 400 may include a driving circuit unit 410, an integrating circuit unit 420, and a capacitor Cm. Hereinafter, operations of the driving circuit unit 410 and the integrating circuit unit 420 will be described in more detail, with reference to FIG. 4.

The driving circuit unit 410 may allow the capacitor Cm to be charged and discharged. The driving circuit unit 410 may include a first switch SW1 connecting a first terminal of the capacitor Cm to a first potential Vcc and a second switch SW2 connecting the first terminal of the capacitor Cm to a second potential GND.

The integrating circuit unit 420 may integrate the charges charged in the capacitor Cm to output the first voltage having the positive polarity and the second voltage having the negative polarity. The integrating circuit unit 420 may include an operational amplifier having a non-inverting input terminal and an inverting output terminal connected to the second terminal of the capacitor Cm through a third switch SW3 and a fourth switch SW4, respectively, a first feedback capacitor Cfb1 connecting between the non-inverting input terminal and a non-inverting output terminal of the operational amplifier, and a second feedback capacitor Cfb2 connecting between an inverting input terminal and the inverting output terminal of the operational amplifier, respectively.

Also, the integrating circuit unit 420 may further include a first reset switch (RSW1) and a second reset RSW2 respectively connected to the first feedback capacitor Cfb1 and the second feedback capacitor Cfb2 in parallel. When the first reset switch RSW1 and the second reset switch RSW2 are turned ON, all of the charges stored in the first feedback capacitor Cfb1 and the second feedback capacitor Cfb2 are discharged, and thus the voltage between both ends thereof may be zero.

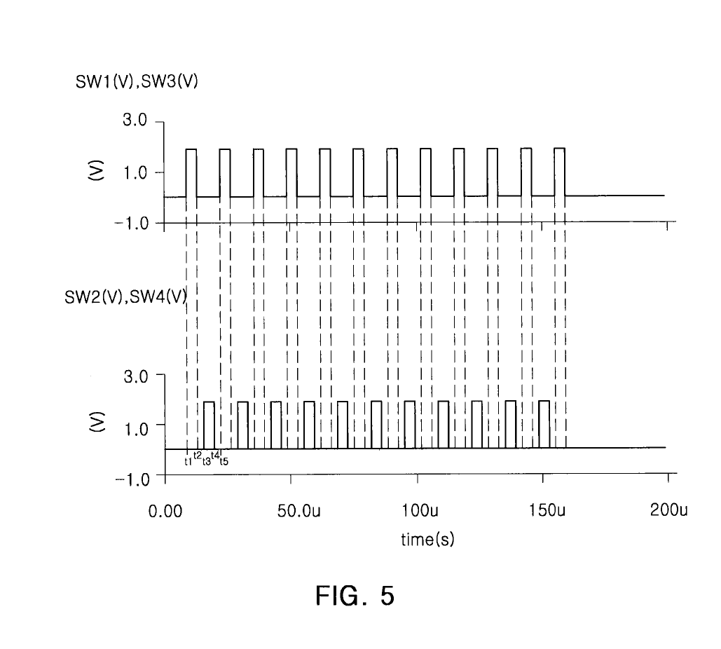

FIG. 5 is a diagram showing the on/off timing of first to fourth switches of the present invention. Referring to FIG. 5, the first switch SW1 and the third switch SW3 may be driven by a first clock and the second switch SW2 and the fourth switch SW4 may be driven by a second clock. The first clock and the second clock may be in an ON-state during different periods thereof. In addition, a time interval while the first clock is in an ON state may be equal to a time interval while the second clock is in an ON state, and a time interval while the first clock is in an OFF state may be equal to a time interval while the second clock is in an OFF state.

That is, the first switch SW1 and the third switch SW3 driven by the first clock and the second switch SW2 and the fourth switch SW4 driven by the second clock may be repeatedly in an ON state without overlapping.

When comparing the above-described touchscreen in FIG. 2 with the capacitance sensing devices in FIGS. 3 and 4, the node capacitors C11˜Cmn in the intersections between the first electrodes and the second electrodes correspond to the capacitors Cm in FIGS. 3 and 4. In addition, the driving circuit unit 210 in FIG. 2 may correspond to the driving circuit units 310 and 410 in FIGS. 3 and 4, and the sensing circuit unit 230 in FIG. 2 may correspond to a component including the integrating circuit unit 320 or 340 in FIG. 3 or 4.

The operation of the capacitance sensing device will be described in detail with reference to FIGS. 4 and 5. It is assumed that the capacitor Cm, the first feedback capacitor Cfb1, and the second feedback capacitor Cfb2 are discharged immediately before a time t1.

Immediately after the time t1, the first switch SW1 and the third switch SW3 are in an ON state and the second switch SW2 and the fourth switch SW4 are in an OFF state. Here, a potential Vo1 in the non-inverting output terminal of the operational amplifier may be expressed by Equation 1 below.

$$Vo 1 = Vcc \frac{Cm}{Cfb 1} \qquad Equation 1$$

Immediately after a time t2, all the first to fourth switches SW1˜SW4 are in an OFF state. The potential difference between both terminals of the capacitor may be maintained at the same level as the first potential Vcc.

Immediately after a time t3, the first switch SW1 and the third switch SW3 are in an OFF state and the second switch SW2 and the fourth switch SW4 are in an ON state. Here, a potential in the inverting output terminal of the operational amplifier may be expressed by Equation 2 below.

$$Vo 2 = - Vcc \frac{Cm}{Cfb 2} \qquad Equation 2$$

Immediately after a time t4, all the first to fourth switches SW1˜SW4 are in an OFF state. The potential different between both terminals of the capacitor may be maintained at the same level as the first potential Vcc. In the case in which the time period of t1˜t5 is repeated N times, the charges stored in the first feedback capacitor and the second feedback capacitor are not discharged, and thus, the potential in the non-inverting output terminal of the operational amplifier and the potential in the inverting output terminal of the operational amplifier may increase or decrease in a stepwise manner. In the case in which the time period of t1˜t5 is repeated N times, a value obtained by deducing the potential in the inverting output terminal from the potential in the non-inverting output terminal may be expressed by Equation 3 below.

$$Δ V = N Δ ( Vo 1 - Vo 2 ) \\ Δ V = N Δ ( Vcc \frac{Cm}{Cfb 1} + Vcc \frac{Cm}{Cfb 2} ) \qquad Equation 3$$

Here, the first feedback capacitor Cfb1 and the second feedback capacitor Cfb2 may have the same capacitance value. When the first feedback capacitor Cfb1 and the second feedback capacitor Cfb2 have the same capacitance value Cfb, Equation 3 may be expressed by the following Equation 4:

$$Δ V = 2 N Δ ( Vcc \frac{Cm}{Cfb} ) \qquad Equation 4$$

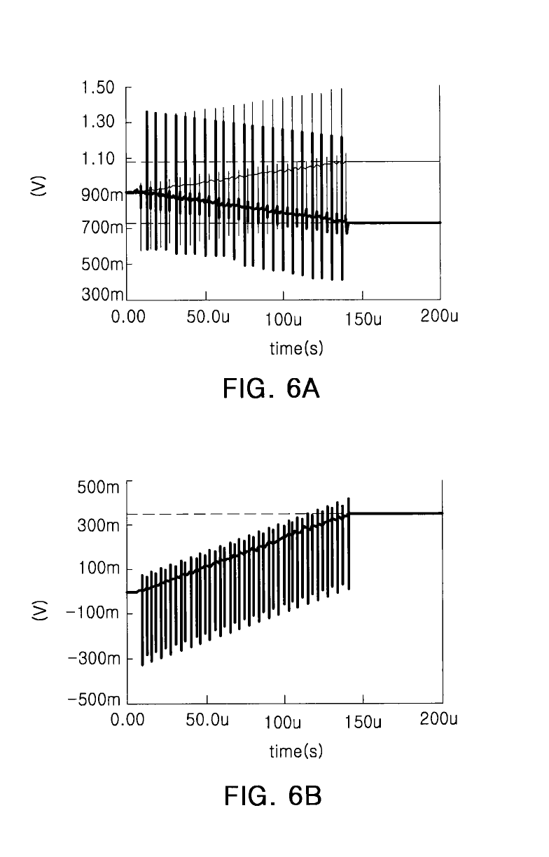

FIGS. 6 to 9 show simulation results according to an embodiment of the present invention.

First, FIG. 6A shows a potential in the non-inverting output terminal of the integrating circuit unit and a potential in the inverting output terminal of the integrating circuit unit in the case in which noise is not input, and FIG. 6B shows a difference between the potential in the non-inverting output terminal and the potential in the inverting output terminal in the case in which noise is not input. Referring to FIG. 6B, the difference between the potential in the non-inverting output terminal and the potential in the inverting output terminal sequentially increases, and exhibits 346.479 mV at about 150 μs.

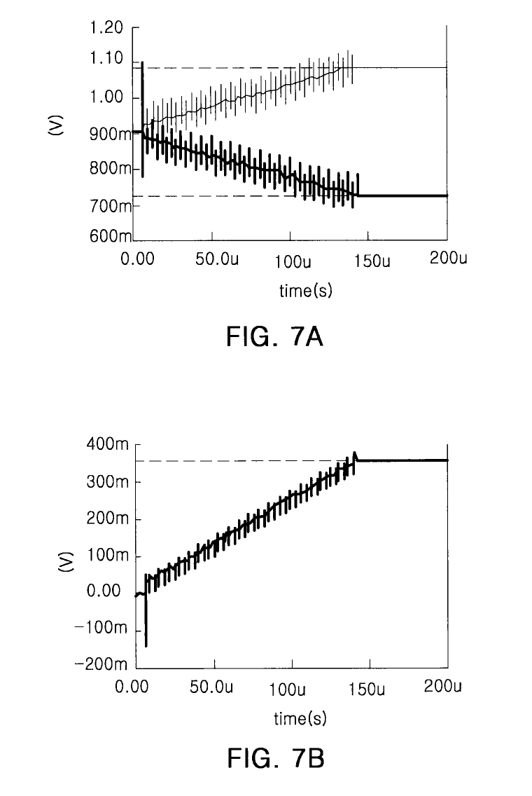

FIGS. 7A and 7B show a case in which noise having a frequency lower than the operational frequency of the first clock and the second clock is input. FIG. 7A shows a potential in the non-inverting output terminal of the integrating circuit unit and a potential in the inverting output terminal of the integrating circuit unit in a case in which noise having a frequency lower than the operational frequency of the first clock and the second clock is input, and FIG. 7B shows a difference between the potential in the non-inverting output terminal and the potential in the inverting output terminal in a case in which noise having a frequency lower than the operational frequency of the first clock and the second clock is input. Referring to FIG. 7B, the difference between the potential in the non-inverting output terminal and the potential in the inverting terminal instantly decreases at 10 μs, due to noise. However, the potential that is finally saturated is 357.614 mV, and this is little different from 346.479 mV, which is the simulation result of FIG. 6B showing the case in which the noise is not input. Therefore, it can be confirmed that the capacitance sensing device according to the embodiment of the present invention removed most influence of noise.

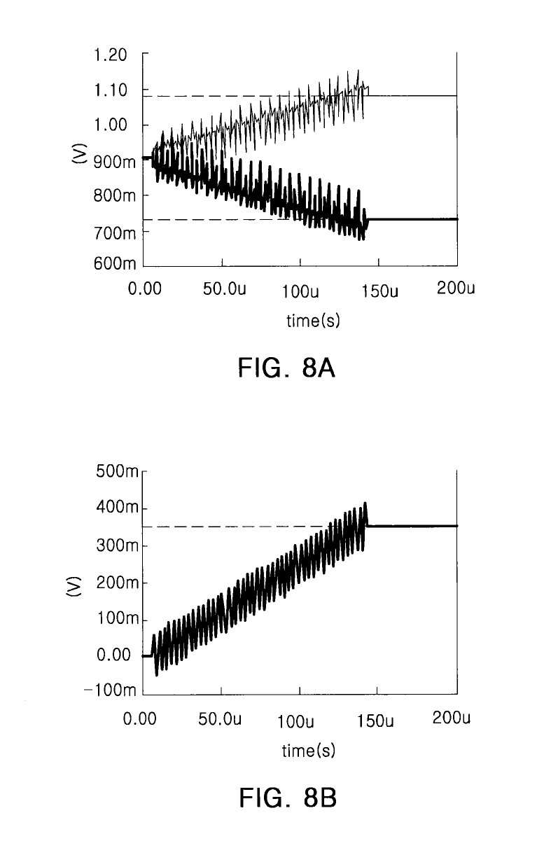

FIGS. 8A and 8B show a case in which noise having a frequency equal to the operational frequency of the first clock and the second clock is input. FIG. 8A shows a potential in the non-inverting output terminal of the integrating circuit unit and a potential in the inverting output terminal of the integrating circuit unit in a case in which noise having a frequency equal to the operational frequency of the first clock and the second clock is input, and FIG. 8B shows a difference between the potential in the non-inverting output terminal and the potential in the inverting output terminal in a case in which noise having a frequency equal to the operational frequency of the first clock and the second clock is input. Referring to FIG. 8B, the difference between the potential in the non-inverting output terminal and the potential in the inverting output terminal increases sequentially, and exhibits 360.582 mV at about 150 μs. This is little different from the simulation result of FIG. 6B showing the case in which noise is not input, and it can be seen that most influence of noise was removed.

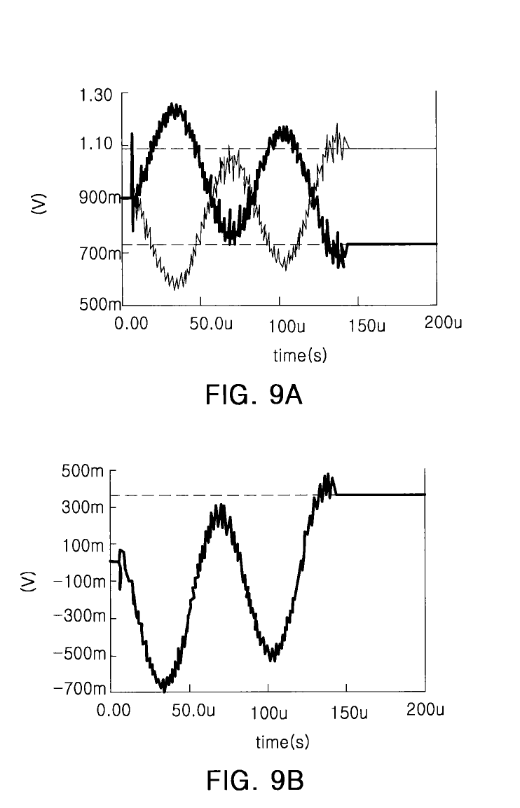

FIGS. 9A and 9B show a case in which noise having a frequency higher than the operational frequency of the first clock and the second clock is input. FIG. 9A shows a potential in the non-inverting output terminal of the integrating circuit unit and a potential in the inverting output terminal of the integrating circuit unit in a case in which noise having a frequency higher than the operational frequency of the first clock and the second clock is input, and FIG. 9B shows a difference between the potential in the non-inverting output terminal and the potential in the inverting output terminal in a case in which noise having a frequency higher than the operational frequency of the first clock and the second clock is input. Referring to FIG. 9B, the difference between the potential in the non-inverting output terminal and the potential in the inverting output terminal increases in the manner of a sine wave, and exhibits 366.224 mV at about 150 μs. This is little different from the simulation result of FIG. 6B showing the case in which noise is not input, and it can be seen that most influence of noise was removed.

As set forth above, according to embodiments of the present invention, the influence of noise can be significantly reduced and a change in capacitance to be measured can be accurately detected, by using a difference in potential between a positive output voltage and a negative output voltage generated by integrating charges stored in a capacitor during different time periods.

While the present invention has been shown and described in connection with the embodiments, it will be apparent to those skilled in the art that modifications and variations can be made without departing from the spirit and scope of the invention as defined by the appended claims.

What is claimed is:

1. A capacitance sensing device, comprising:
a driving circuit unit allowing a capacitor to be charged and discharged; and
an integrating circuit unit integrating charges stored in the capacitor,
wherein the integrating circuit unit integrates the charges stored in the capacitor to thereby output a first voltage having a positive polarity and a second voltage having a negative polarity.

2. The capacitance sensing device of claim 1, wherein in the integrating circuit unit, an integrating period in which the first voltage having the positive polarity is output does not overlap with an integrating period in which the second voltage having the negative polarity is output.

3. The capacitance sensing device of claim 1, wherein the driving circuit unit includes:
a first switch connecting a first terminal of the capacitor to a first potential; and
a second switch connecting the first terminal of the capacitor to a second potential.

4. The capacitance sensing device of claim 3, wherein the integrating circuit unit includes:
a third switch having one end connected to a second terminal of the capacitor;
a fourth switch having one end connected to the second terminal of the capacitor;
an operational amplifier having a non-inverting input terminal and an inverting input terminal respectively connected to the other end of the third switch and the other end of the fourth switch;
a first feedback capacitor connecting the non-inverting input terminal and a non-inverting output terminal of the operational amplifier; and
a second feedback capacitor connecting the inverting input terminal and an inverting output terminal of the operational amplifier.

5. The capacitance sensing device of claim 4, wherein the first switch and the third switch are driven by a first clock and the second switch and the fourth switch are driven by a second clock, and
the first clock and the second clock are in an ON-state during different time periods.

6. The capacitance sensing device of claim 4, wherein the first feedback capacitor and the second feedback capacitor have the same capacitance.

7. The capacitance sensing device of claim 3, wherein the integrating circuit unit further includes a first reset switch and a second reset switch respectively connected to the first feedback capacitor and the second feedback capacitor in parallel.

8. A touchscreen, comprising:
a panel unit including a plurality of driving electrodes and a plurality of sensing electrodes;
a driving circuit unit applying a driving signal to each of the plurality of driving electrodes;
a sensing circuit unit sensing changes in capacitance generated in intersections between the driving electrodes to which the driving signal is applied and the sensing electrodes; and
a control unit controlling operations of the driving circuit unit and the sensing circuit unit,
wherein the sensing circuit unit includes an integrating circuit unit integrating charges stored in the sensing electrodes to thereby output a first voltage having a positive polarity and a second voltage having a negative polarity.

9. The touchscreen of claim 8, wherein, in the integrating circuit unit, an integrating period in which the first voltage having the positive polarity is output does not overlap with an integrating period in which the second voltage having the negative polarity is output.

10. The touchscreen of claim 8, wherein the control unit determines a touch input applied to the panel unit depending on a difference between the first voltage having the positive polarity and the second voltage having the negative polarity output from the integrating circuit unit.
